(19) United States
(12) Patent Application Publication
(10) Pub. No.: US 2025/0218146 A1
(43) Pub. Date: Jul. 3, 2025

(54) EYE IMAGE ACQUISITION SYSTEM AND VIRTUAL IMAGE DISPLAY DEVICE

(71) Applicant: FUJIFILM Corporation, Tokyo (JP)

(72) Inventors: Naoyoshi YAMADA, Minamiashigara-shi (JP); Ryuji SANETO, Minamiashigara-shi (JP)

(73) Assignee: FUJIFILM Corporation, Tokyo (JP)

(21) Appl. No.: 19/082,895

(22) Filed: Mar. 18, 2025

Related U.S. Application Data
(63) Continuation of application No. PCT/JP2023/035214, filed on Sep. 27, 2023.

(30) Foreign Application Priority Data
Sep. 30, 2022 (JP) 2022-157971

(51) Int. Cl. G06V 10/141; G02B 27/01; G06V 10/147

(52) U.S. Cl. CPC G06V 10/141; G02B 27/0172; G06V 10/147

(57) ABSTRACT

An object is to provide an eye image acquisition system that is mounted on a VR system, an AR system, or the like and where a reduction in size can be achieved and a structure is also simple. The eye image acquisition system includes: an infrared source that emits infrared light to an eyeball of a user; a light guide unit that guides the infrared light emitted from the infrared source and reflected from the eyeball; an emission element that emits the infrared light guided in the light guide unit from the light guide unit; an imaging unit that images the infrared light emitted from the light guide unit; and a reflection element that reflects the infrared light emitted from the infrared source and reflected from the eyeball and collimates the reflected light to guide the collimated infrared light in the light guide unit.

### CROSS-REFERENCE TO RELATED APPLICATIONS

This application is a Continuation of PCT International Application No. PCT/JP2023/035214 filed on Sep. 27, 2023, which claims priority under 35 U.S.C. § 119(a) to Japanese Patent Application No. 2022-157971 filed on Sep. 30, 2022. The above applications are hereby expressly incorporated by reference, in their entirety, into the present application.

### BACKGROUND OF THE INVENTION

### 1. Field of the Invention

The present invention relates to an eye image acquisition system used for a head mounted display or the like, and a virtual image display device on which the eye image acquisition system is mounted.

### 2. Description of the Related Art

As means for providing a user with virtual reality (VR) and augmented reality (AR), a head mounted display (HMD), AR glasses, or the like has been put into practical use.

In a VR system that provides VR and an AR system that provides AR, for example, it is desired to acquire the expression of a user and to detect a gaze direction of the user. Accordingly, a device on which the eye image acquisition system is mounted is also known.

For example, as a head mounted display system (HMD), JP2022-502701A discloses a system including: an image projector that projects an image to be observed to a user; a camera; a waveguide; a coupling optical element that introduces and guides light into the waveguide by diffraction; and an out-coupling element that emits the light guided in the waveguide from the waveguide to direct the emitted light to the camera,
in which the camera is disposed in an optical path with respect to the out-coupling element to receive at least a part of the light that is incident into the waveguide by the coupling optical element, is guided in the waveguide, and is emitted, and
the coupling optical element is configured to cause light reflected from an anterior portion of an eye of the user to be incident into the waveguide and to guide the reflected light such that an image of the eye of the user can be captured by the camera and the camera complements an image of the anterior portion of the eye of the user.

### SUMMARY OF THE INVENTION

As in the HMD described in JP2022-502701A, by mounting the eye image acquisition system on the VR system and the AR system and detecting the expression, the gaze direction, and the like of the user, for example, information corresponding to an image to be displayed can be further displayed in the gaze direction.

Therefore, by mounting the eye image acquisition system, the convenience of the VR system and the AR system can be improved.

Here, recently, a reduction in the size of the VR system and the AR system such as an HMD is desired. Accordingly, a reduction in size is also desired for the eye image acquisition system mounted on the VR system and the AR system.

An object of the present invention is to solve the above-described problem of the related art and to provide an eye image acquisition system that is mounted on a VR system, an AR system, or the like such as an HMD or AR glasses and where a reduction in size can be achieved and a structure is also simple.

In order to achieve the object, the present invention has the following configurations.

[1] An eye image acquisition system comprising:
an infrared source that emits infrared light to an eyeball of a user;
a light guide unit that guides the infrared light emitted from the infrared source and reflected from the eyeball of the user;
an emission element that emits the infrared light guided in the light guide unit from the light guide unit;
an imaging unit that images the infrared light emitted from the light guide unit by the emission element; and
a reflection element that reflects the infrared light emitted from the infrared source and reflected from the eyeball of the user and collimates the reflected light to guide the collimated infrared light in the light guide unit.

[2] The eye image acquisition system according to [1],
in which the reflection element is encompassed in the light guide unit and is bent.

[3] The eye image acquisition system according to [1] or [2],
in which the reflection element reflects infrared light using a cholesteric liquid crystal layer.

[4] The eye image acquisition system according to any one of [1] to [3],
in which the reflection element reflects infrared light using a cholesteric liquid crystal layer,
the cholesteric liquid crystal layer has a liquid crystal alignment pattern in which an optical axis derived from a liquid crystal compound changes while continuously rotating in at least one in-plane direction, and
in a case where a length over which the optical axis rotates by 180° is set as a single period, the cholesteric liquid crystal layer has regions having different single periods in the plane.

[5] The eye image acquisition system according to any one of [1] to [4],
in which the infrared light emitted from the infrared source is incident into and guided in the light guide unit, is emitted from the light guide unit by the reflection element, and is incident into the eyeball of the user.

[6] A virtual image display device comprising:
the eye image acquisition system according to any one of [1] to [5];
an image display apparatus; and
a virtual image generation optical system.

[7] The virtual image display device according to [6],
in which the virtual image generation optical system is a folded optical system.

According to the present invention it is possible to provide an eye image acquisition system that is mounted on a VR system, an AR system, or the like and where a reduction in size can be achieved and a structure is also simple.

### BRIEF DESCRIPTION OF THE DRAWINGS

FIG. 1 is a conceptual diagram showing an example of an eye image acquisition system according to the present invention.

FIG. 2 is a conceptual diagram showing an example of a reflection element including a cholesteric liquid crystal layer.

FIG. 3 is a schematic plan view showing an example of the cholesteric liquid crystal layer.

FIG. 4 is a conceptual diagram showing an example of a cross sectional SEM image of the cholesteric liquid crystal layer.

FIG. 5 is a conceptual diagram showing an action of the cholesteric liquid crystal layer.

FIG. 6 is a conceptual diagram showing another example of the eye image acquisition system according to the present invention.

FIG. 7 is a conceptual diagram showing another example of the eye image acquisition system according to the present invention.

FIG. 8 is a conceptual diagram showing another example of the eye image acquisition system according to the present invention.

### DESCRIPTION OF THE PREFERRED EMBODIMENTS

Hereinafter, an eye image acquisition system and a virtual image display device according to an embodiment of the present invention will be described in detail based on a preferable embodiment shown in the drawings.

In the present specification, a numerical range expressed using “to” refers to a range including numerical values described before and after “to” as a lower limit value and an upper limit value.

In the present invention, visible light refers to light having a wavelength of 380 nm or more and less than 700 nm. In addition, infrared light refers to light having a wavelength of 700 nm to 1 mm.

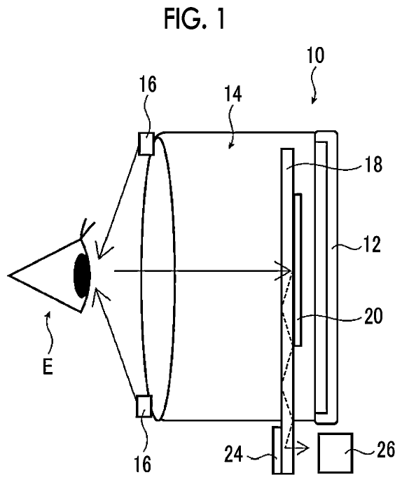

FIG. 1 conceptually shows an example of a virtual image display device according to an embodiment of the present invention on which an eye image acquisition system according to an embodiment of the present invention is mounted.

A virtual image display device 10 shown in FIG. 1 is the above-described HMD and includes an image display apparatus 12 and a virtual image generation optical system 14. In addition, the eye image acquisition system incorporated into the virtual image display device 10 includes an infrared source 16, a light guide unit 18, a reflection element 20, an emission element 24, and an imaging unit 26.

In the virtual image display device 10 according to the embodiment of the present invention, the image display apparatus 12 is not limited, and various well-known image display apparatuses (displays), such as a liquid crystal display device or an organic electroluminescent display device, that are used for an HMD or the like can be used.

In addition, the virtual image generation optical system 14 is a well-known virtual image generation optical system that is used for an HMD or the like and includes a lens, a mirror, a folded optical system called a pancake lens, and a light guide plate for displaying augmented reality.

As described above, the eye image acquisition system incorporated into the virtual image display device 10 includes an infrared source 16, a light guide unit 18, a reflection element 20, an emission element 24, and an imaging unit 26.

In the eye image acquisition system, the infrared source 16 emits infrared light toward an eyeball E of a user.

The infrared light emitted from the infrared source 16 is reflected from the eyeball E of the user, transmits through the light guide unit 18, and is incident into the reflection element 20.

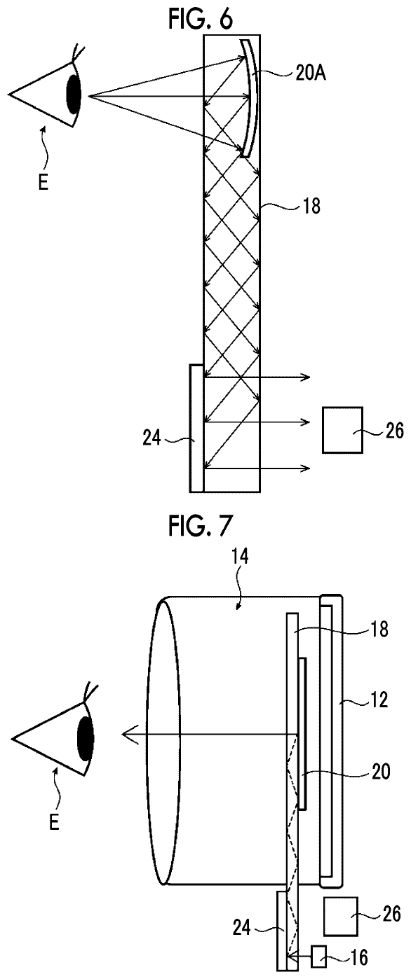

The reflection element 20 is a reflection element that selectively reflects infrared light and allows transmission of visible light. In addition, instead of specularly reflecting the incident infrared light, the reflection element 20 reflects the infrared light at an angle where the infrared light is totally reflected and guided in the light guide unit 18, is incident into the light guide unit 18, and is guided in the light guide unit 18. In addition, the infrared light reflected from the eyeball E is diffused light. During the reflection of the infrared light, the reflection element 20 collimates the infrared light into parallel light (state close to parallel light) and causes the parallel light to be incident into the light guide unit 18 (refer to FIG. 6). The parallel light includes light in a state close to parallel light.

The infrared light incident into the light guide unit 18 is guided (propagates) while repeating total reflection at an interface between the light guide unit 18 and air, and is incident into the emission element 24.

Instead of specularly reflecting the incident infrared light, the emission element 24 can emit the incident infrared light from the light guide unit 18 can emit the incident infrared light at an angle toward the imaging unit 26.

The infrared light reflected from the emission element 24 is emitted from the light guide unit 18, is incident into the imaging unit 26, and is imaged. The eye image acquisition system in the example shown in the drawing acquires (images) an eye image of the eyeball E of the user as described above.

This way, the eye image acquisition system according to the embodiment of the present invention includes: the light guide unit 18; the reflection element 20 that reflects the infrared light reflected from the eyeball E to be incident into the light guide unit 18 at an angle where the light is totally reflected and guided, and collimates the infrared light reflected from the eyeball E; and the emission element 24 that emits the infrared light totally reflected and guided in the light guide unit 18 from the light guide unit 18. As a result, a reduction in the size of the system can be achieved, and the configuration can be simplified.

In addition, by collimating the infrared light reflected from the eyeball E by the reflection element 20, an appropriate image of the eyeball E can be acquired.

Further, in the eye image acquisition system according to the embodiment of the present invention including the light guide unit 18, the image of the eyeball E can be acquired from an angle close to the front, which can achieve, for example, improvement or the like of the detection accuracy of the gaze direction.

In the eye image acquisition system according to the embodiment of the present invention, the infrared source 16 is not limited, and various well-known light sources (light emitting elements) such as a light-emitting diode (LED), a semiconductor laser (laser diode (LD)), or an organic electroluminescence can be used.

In addition, a wavelength of the infrared light emitted from the infrared source 16 is not limited and only needs to be in the above-described wavelength range of the infrared light. The wavelength of the infrared light emitted from the infrared source 16 is preferably 700 to 1000 nm and more preferably 800 to 900 nm.

In the example shown in FIG. 1, two infrared sources 16 are provided for the eyeball E, but the present invention is not limited thereto. One infrared source 16 may be provided, or optionally three or more infrared sources 16 may be provided. From the viewpoint of improving the detection accuracy of the gaze direction, the number of the infrared sources 16 is preferably 3 or more and more preferably 6 or more.

In the eye image acquisition system according to the embodiment of the present invention, the light guide unit 18 is also not limited, and various well-known light guide plates such as a glass light guide plate or a plastic light guide plate including an acrylic resin light guide plate can be used as long as they can allow transmission of visible light and can guide infrared light.

As described above, the reflection element 20 reflects the infrared light reflected from the eyeball E to be incident into the light guide unit 18 at an angle where total reflection can occur in the light guide unit 18, and guides the infrared light in the light guide unit 18. In addition, the reflection element 20 collimates the infrared light reflected from the eyeball E that is diffused light into parallel light (substantially parallel light) (refer to FIG. 6). The reflection element 20 selectively reflects infrared light and allows transmission of visible light.

The collimation of the infrared light reflected from the eyeball E that is diffused light will be described below in detail.

In the example shown in FIG. 1, for example, the reflection element 20 is bonded to the light guide unit 18 using well-known bonding means, such as an optical clear adhesive (OCA), capable of allowing transmission of visible light.

As the reflection element 20, various well-known optical elements can be used as long as they can exhibit the above-described action. As the reflection element, for example, a cholesteric liquid crystal layer, a half mirror that is formed thin using a metal such as aluminum, a dielectric multi-layer film, or a volume hologram can be used.

In particular, the cholesteric liquid crystal layer is most preferable from the viewpoints that infrared light can be reflected with high efficiency, the transmittance with respect to visible light is high, and there is no influence on the optical path of visible light.

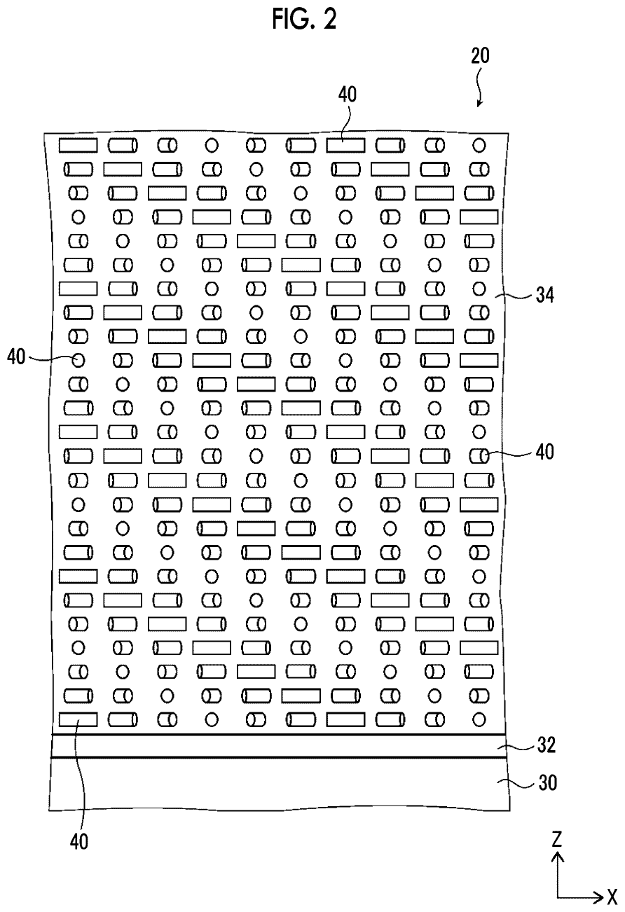

FIG. 2 conceptually shows an example of the reflection element 20 including the cholesteric liquid crystal layer.

For example, this reflection element 20 includes a support 30, an alignment film 32, and a cholesteric liquid crystal layer 34.

The reflection element 20 including the cholesteric liquid crystal layer 34 is not limited to that including the support 30, the alignment film 32, and the cholesteric liquid crystal layer 34 as shown in FIG. 2.

For example, the reflection element 20 including the cholesteric liquid crystal layer 34 may consist of only the cholesteric liquid crystal layer 34 by peeling off the alignment film 32 and the support 30 after forming the cholesteric liquid crystal layer 34, or may consist of the alignment film 32 and the cholesteric liquid crystal layer 34 by peeling off the support 30 after forming the cholesteric liquid crystal layer 34.

In addition, a plurality of cholesteric liquid crystal layers may be laminated. From the viewpoint of increasing the reflectivity of infrared light, it is preferable that a left-twisted cholesteric liquid crystal layer that selectively reflects a left circularly polarized light component of infrared light and a right-twisted cholesteric liquid crystal layer that selectively reflects a right circularly polarized light component of infrared light are laminated.

In addition, in order for the reflection element 20 not to change a polarization state of visible light, it is preferable that both phase differences in the front direction and an oblique direction of the cholesteric liquid crystal layer are small. From the viewpoint of suppressing the phase difference in the oblique direction, it is preferable that a cholesteric liquid crystal layer formed of a disk-like liquid crystal compound and a cholesteric liquid crystal layer formed of a disk-like liquid crystal compound are laminated.

In a case where the cholesteric liquid crystal layers are laminated, the plurality of cholesteric liquid crystal layers may be laminated directly or through an alignment film or an adhesive layer.

In a preferable aspect, the cholesteric liquid crystal layer 34 shown in FIG. 2 has a liquid crystal alignment pattern in which an optical axis derived from a liquid crystal compound continuously rotates in one direction.

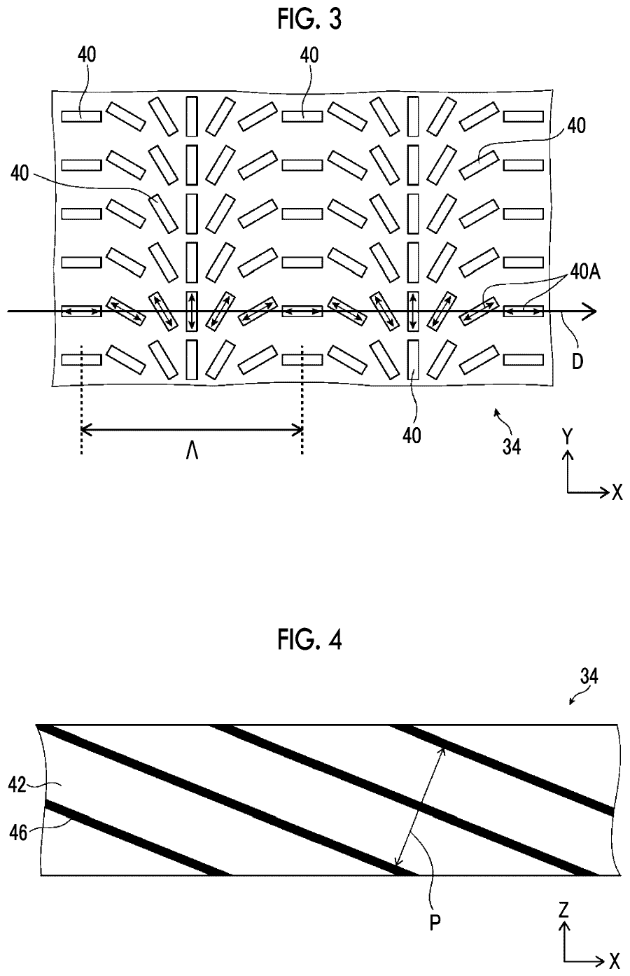

FIG. 3 is a schematic diagram showing an alignment state of a liquid crystal compound in a plane of a main surface of the cholesteric liquid crystal layer 34.

In the following description, it is assumed that a main surface of the cholesteric liquid crystal layer 34 is an X-Y plane and a cross section perpendicular to the X-Y plane is an X-Z plane. That is, FIG. 2 corresponds to a schematic diagram of the X-Z plane of the cholesteric liquid crystal layer 34, and FIG. 3 corresponds to a schematic diagram of the X-Y plane of the cholesteric liquid crystal layer 34.

The main surface is each of the maximum surfaces of a sheet-shaped material (a film, a plate-shaped material, a layer, or a film), that is, both surfaces in the thickness direction.

The cholesteric liquid crystal layer 34 is a layer formed by cholesteric alignment of a liquid crystal compound. In addition, FIGS. 2 and 3 show an example in which the liquid crystal compound forming the cholesteric liquid crystal layer 34 is a rod-like liquid crystal compound. Accordingly, in the example shown in the drawing, a direction of an optical axis 40A derived from a liquid crystal compound 40 matches with a longitudinal direction of the liquid crystal compound 40.

### Support

The support 30 is a sheet-shaped material that supports the alignment film 32 and the cholesteric liquid crystal layer 34.

As the support 30, various sheet-shaped materials such as a resin film or a glass plate can be used as long as they can support the alignment film 32 and the cholesteric liquid crystal layer 34.

In a case where the reflection element 20 includes the support 30, it is preferable that the support 30 has sufficient transmittance with respect to visible light and the phase differences in the front direction and the oblique direction are small.

In addition, the support 30 may be peeled off after forming the cholesteric liquid crystal layer.

### Alignment Film

In the reflection element 20 including the cholesteric liquid crystal layer 34, the alignment film 32 is formed on a surface of the support 30.

The alignment film 32 is an alignment film for aligning the liquid crystal compound 40 to a predetermined liquid crystal alignment pattern during the formation of the cholesteric liquid crystal layer 34.

In a preferable aspect, although described below, in the example shown in the drawing, the cholesteric liquid crystal layer 34 has a liquid crystal alignment pattern in which an orientation of the optical axis 40A (refer to FIG. 3) derived from the liquid crystal compound 40 changes while continuously rotating in one in-plane direction. Accordingly, the alignment film 32 forms an alignment pattern such that the cholesteric liquid crystal layer 34 can form the liquid crystal alignment pattern.

In the following description, “the orientation of the optical axis 40A rotates” will also be simply referred to as “the optical axis 40A rotates”.

As the alignment film 32, various well-known alignment films that are used for aligning a liquid crystal compound can be used.

In particular, as the alignment film 32, a photo-alignment film including a photo-alignment material is preferably used. That is, the alignment film 32 is preferably a so-called photo-alignment film obtained by irradiating a photo-alignment material with polarized light or non-polarized light.

Preferable examples of the photo-alignment material used in the photo-alignment film that can be used in the present invention include: an azo compound described in JP2006-285197A, JP2007-076839A, JP2007-138138A, JP2007-094071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking polyester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-012823A.

Among these, an azo compound, a photocrosslinking polyimide, a photocrosslinking polyamide, a photocrosslinking polyester, a cinnamate compound, or a chalcone compound is suitably used.

The thickness of the alignment film 32 is not particularly limited. The thickness with which a required alignment function can be obtained may be appropriately set depending on the material for forming the alignment film 32.

A method of forming the alignment film 32 is not limited. Any one of various well-known methods corresponding to a material for forming the alignment film 32 can be used.

In a case where the alignment film 32 is a photo-alignment film, for example, the alignment film 32 is formed by preparing a composition including a photo-alignment material for forming the photo-alignment film 32, applying this composition to a surface of the support 30, and drying the applied composition. Next, through interference exposure of the alignment film 32 to laser light, an alignment pattern is formed such that the orientation of the optical axis 40A changes while continuously rotating in one in-plane direction. (refer to FIG. 3).

### Cholesteric Liquid Crystal Layer

The cholesteric liquid crystal layer 34 is formed on a surface of the alignment film 32.

The cholesteric liquid crystal layer 34 is a cholesteric liquid crystal layer obtained by immobilizing a cholesteric liquid crystalline phase. In addition, the cholesteric liquid crystal layer 34 in the example shown in the drawing has a liquid crystal alignment pattern in which an orientation of an optical axis derived from a liquid crystal compound changes while continuously rotating in at least one in-plane direction.

The cholesteric liquid crystal layer 34 having the liquid crystal alignment pattern acts as a reflective liquid crystal diffraction element that diffracts and reflects incidence light.

As conceptually shown in FIG. 2, the cholesteric liquid crystal layer 34 has a helical structure in which the liquid crystal compound 40 is helically turned and laminated as in a cholesteric liquid crystal layer obtained by immobilizing a typical cholesteric liquid crystalline phase. In the helical structure, a configuration in which the liquid crystal compound 40 is helically rotated once (rotated by) 360° and laminated is set as one helical pitch (helical pitch P), and plural pitches of the helically turned liquid crystal compound 40 are laminated.

It is known that the cholesteric liquid crystalline phase exhibits selective reflectivity where light in a specific wavelength range is selectively reflected.

A central wavelength of selective reflection (selective reflection center wavelength λ) of a cholesteric liquid crystalline phase depends on the length of one helical pitch (helical pitch P) in the cholesteric liquid crystalline phase and satisfies a relationship of λ=n×P with an average refractive index n of the cholesteric liquid crystalline phase.

Therefore, the selective reflection center wavelength, that is, the selective reflection wavelength range can be adjusted by adjusting the helical pitch. The selective reflection center wavelength of the cholesteric liquid crystalline phase increases as the helical pitch P increases.

In the eye image acquisition system according to the embodiment of the present invention, the reflection element 20 allows transmission of visible light and selectively reflects infrared light. Accordingly, the helical pitch P of the cholesteric liquid crystalline phase is appropriately set depending on the wavelength of the infrared light emitted from the infrared source 16.

The helical pitch of the cholesteric liquid crystalline phase depends on the kind of the chiral agent used together with the liquid crystal compound 40 and the concentration of the chiral agent added during the formation of the cholesteric liquid crystal layer. Therefore, a desired helical pitch can be obtained by adjusting these conditions.

The details of the adjustment of the pitch can be found in “Fuji Film Research & Development” No. 50 (2005), p. 60 to 63. As a method of measuring a sense of helix and a helical pitch, a method described in “Introduction to Experimental Liquid Crystal Chemistry”, (the Japanese Liquid Crystal Society, 2007, Sigma Publishing Co., Ltd.), p. 46, and “Liquid Crystal Handbook” (the Editing Committee of Liquid Crystal Handbook, Maruzen Publishing Co., Ltd.), p. 196 can be used.

In addition, a half-width Δλ (nm) of a wavelength range (circularly polarized light reflection wavelength range) where selective reflection is exhibited depends on Δn of the cholesteric liquid crystalline phase and the helical pitch P and satisfies a relationship of Δλ=Δn×P. Therefore, the width of the selective reflection wavelength range can be controlled by adjusting Δn. Δn can be adjusted by adjusting a kind of a liquid crystal compound for forming the cholesteric liquid crystal layer and a mixing ratio thereof, and a temperature during alignment immobilization.

As is well known, the cholesteric liquid crystalline phase exhibits selective reflectivity with respect to left or circularly polarized light in a specific wavelength range. Whether the reflected light is right circularly polarized light or left circularly polarized light is determined depending on a helical twisted direction (sense) of the cholesteric liquid crystalline phase. Regarding the selective reflection of the circularly polarized light by the cholesteric liquid crystal phase, in a case where the helical twisted direction of the cholesteric liquid crystal phase is right, right circularly polarized light is reflected, and in a case where the helical twisted direction of the cholesteric liquid crystal phase is left, left circularly polarized light is reflected.

Accordingly, for example, in a case where the cholesteric liquid crystal layer selectively reflects right circularly polarized light, in the cholesteric liquid crystal layer 34, the helical twisted direction of the cholesteric liquid crystalline phase is the right direction.

A turning direction of the cholesteric liquid crystal phase can be adjusted by adjusting the kind of the liquid crystal compound that forms the cholesteric liquid crystal layer and/or the kind of the chiral agent to be added.

As shown in FIG. 3, in the X-Y plane of the cholesteric liquid crystal layer 34, the liquid crystal compounds 40 are arranged along a plurality of arrangement axes D parallel to the X-Y plane. On each of the arrangement axes D, the orientation of the optical axis 40A of the liquid crystal compound 40 changes while continuously rotating in the one in-plane direction along the arrangement axis D. Here, for example, it is assumed that the arrangement axis D is directed to the X direction. In addition, in the Y direction, the liquid crystal compounds 40 in which the orientations of the optical axes 40A are the same are aligned at regular intervals.

“The orientation of the optical axis 40A of the liquid crystal compound 40 changes while continuously rotating in the one in-plane direction along the arrangement axis D” represents that angles between the optical axes 40A of the liquid crystal compounds 40 and the arrangement axes D vary depending on positions in the arrangement axis D direction and gradually change from θ to θ+180° or θ−180° along the arrangement axis D. That is, in each of the plurality of liquid crystal compounds 40 arranged along the arrangement axis D, as shown in FIG. 3, the optical axis 40A changes along the arrangement axis D while rotating on a given angle basis.

A difference between the angles of the optical axes 40A of the liquid crystal compounds 40 adjacent to each other in the arrangement axis D direction is preferably 45° or less, more preferably 15° or less, and still more preferably less than 15°.

In addition, as described above, in a case where the liquid crystal compound 40 is a rod-like liquid crystal compound, the optical axis 40A of the liquid crystal compound 40 refers to a molecular major axis of the rod-like liquid crystal compound. On the other hand, in a case where the liquid crystal compound 40 is a disk-like liquid crystal compound, the optical axis 40A of the liquid crystal compound 40 refers to an axis parallel to the normal direction with respect to a disc plane of the disk-like liquid crystal compound.

In the cholesteric liquid crystal layer 34, in the liquid crystal alignment pattern of the liquid crystal compound 40, the length (distance) over which the optical axis 40A of the liquid crystal compound 40 rotates by 180° in the arrangement axis D direction in which the optical axis 40A changes while continuously rotating in a plane is the length A of the single period in the liquid crystal alignment pattern.

That is, a distance between centers of two liquid crystal compounds 40 in the arrangement axis D direction is the length Λ of the single period, the two liquid crystal compounds 40 having the same angle in the arrangement axis D direction. Specifically, as shown in FIG. 3, a distance between centers in the arrangement axis D direction of two liquid crystal compounds 40 in which the arrangement axis D direction and the direction of the optical axis 40A match with each other is the length Λ of the single period. In the following description, the length Λ of the single period will also be referred to as “single period Λ”.

In the liquid crystal alignment pattern of the cholesteric liquid crystal layer 34, the single period A is repeated in the arrangement axis D direction, that is, in the one in-plane direction in which the orientation of the optical axis 40A changes while continuously rotating. In the liquid crystal diffraction element, the single period A is the period (diffraction period) of the diffraction structure in the diffraction element.

On the other hand, in the liquid crystal compound 40 forming the cholesteric liquid crystal layer 34, the orientations of the optical axes 40A are the same in the direction (in FIG. 3, the Y direction) orthogonal to the arrangement axis D direction, that is, the Y direction perpendicular to the one in-plane direction in which the optical axis 40A continuously rotates.

In other words, in the liquid crystal compound 40 forming the cholesteric liquid crystal layer 34, angles between the optical axes 40A of the liquid crystal compound 40 and the arrow X direction are the same in the Y direction.

In a case where a cross section of the cholesteric liquid crystal layer in a thickness direction is observed with a scanning electron microscope (SEM), a stripe pattern in which bright portions and dark portions derived from a cholesteric liquid crystalline phase are alternately arranged is observed. The cross section of the cholesteric liquid crystal layer in the thickness direction is a cross section in a direction orthogonal to a main surface and is a cross section in a laminating direction of the respective layers (films).

In a typical cholesteric liquid crystal layer not having the liquid crystal alignment pattern, the stripe pattern of the bright portions and the dark portions are parallel to a main surface.

On the other hand, in a case where a cross section of the cholesteric liquid crystal layer 34 having the liquid crystal alignment pattern shown in FIG. 2 in a thickness direction, that is, an X-Z plane is observed with a SEM, as conceptually shown in FIG. 4, a stripe pattern where the bright portions 42 and the dark portions 46 that are alternately arranged is tilted at a predetermined angle with respect to the main surface (X-Y plane) is observed.

In this SEM cross section, an interval between the bright portions 42 adjacent to each other or between the dark portions 46 adjacent to each other in a normal direction of lines formed by the bright portions 42 or the dark portions 46 corresponds to a ½ pitch. That is, as indicated by P in FIG. 4, two bright portions 42 and two dark portions 46 correspond to one helical pitch (one helical turn), that is, the helical pitch P.

Hereinafter, an action of diffraction (reflection) by the cholesteric liquid crystal layer 34 having the liquid crystal alignment pattern will be described.

In the cholesteric liquid crystal layer of the related art not having the liquid crystal alignment pattern, a helical axis derived from a cholesteric liquid crystalline phase is perpendicular to the main surface (X-Y plane), and a reflecting surface thereof is parallel to the main surface (X-Y plane). In addition, the optical axis of the liquid crystal compound is not tilted with respect to the main surface (X-Y plane). In other words, the optical axis is parallel to the main surface (X-Y plane).

Accordingly, in a case where a cross section (X-Z plane) of the typical cholesteric liquid crystal layer in a thickness direction is observed with a SEM, as described above, the bright portions and the dark portions that are alternately arranged are parallel to the main surface (X-Y plane), that is, a direction in which the bright portions and the dark portions are alternately arranged is perpendicular to the main surface.

The cholesteric liquid crystal phase has specular reflectivity. Therefore, in a case where light is incident from the normal direction into the cholesteric liquid crystal layer, the light is reflected in the normal direction.

On the other hand, as described above, the cholesteric liquid crystal layer 34 has the liquid crystal alignment pattern in which the optical axis 40A changes while continuously rotating in the arrangement axis D direction in a plane (the predetermined one in-plane direction).

The cholesteric liquid crystal layer 34 having the liquid crystal alignment pattern reflects incident light in a state where it is tilted in the arrangement axis D direction with respect to the specular reflection.

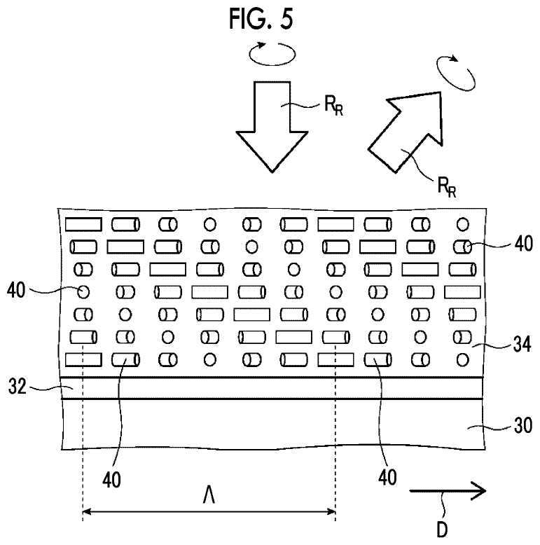

Hereinafter, the description will be made with reference to the conceptual diagram of FIG. 5.

For example, the cholesteric liquid crystal layer 34 selectively reflects right circularly polarized light R_{R} of infrared light. Accordingly, in a case where light is incident into the cholesteric liquid crystal layer 34, the cholesteric liquid crystal layer 34 reflects only right circularly polarized light R_{R} of infrared light and allows transmission of the other light.

Here, in the cholesteric liquid crystal layer 34, the optical axis 40A of the liquid crystal compound 40 changes while rotating in the arrangement axis D direction (the one in-plane direction).

In addition, the liquid crystal alignment pattern formed in the cholesteric liquid crystal layer 34 is a pattern that is periodic in the arrangement axis D direction. Therefore, as conceptually shown in FIG. 5, the right circularly polarized light R_{R} of infrared light incident into the cholesteric liquid crystal layer 34 is diffracted in a direction corresponding to the period of the liquid crystal alignment pattern without being specularly reflected, and is diffracted and reflected in a direction tilted in the arrangement axis D direction with respect to the X-Y plane (the main surface of the cholesteric liquid crystal layer).

For example, in a case where the right circularly polarized light R_{R} is incident from the normal direction of the cholesteric liquid crystal layer 34, the right circularly polarized light R_{R} is reflected at an angle in the direction of the arrangement axes D with respect to the normal direction instead of being reflected in the normal direction.

The normal direction is a direction orthogonal to the surface, and is a direction orthogonal to the main surface in the cholesteric liquid crystal layer 34.

Therefore, by using the reflection element 20 including the cholesteric liquid crystal layer 34 having the liquid crystal alignment pattern that is the reflective liquid crystal diffraction element, the infrared light reflected from the eyeball E can be diffracted and reflected to be incident into the light guide unit 18 at an angle where the infrared light can be totally reflected and guided in the light guide unit 18.

In the cholesteric liquid crystal layer 34, by appropriately setting the arrangement axis D direction as the one in-plane direction in which the optical axis 40A rotates, the diffraction direction, that is, the reflection direction of light can be adjusted.

In addition, in a case where circularly polarized light having the same wavelength and the same turning direction is reflected, by reversing the rotation direction of the optical axis 40A of the liquid crystal compound 40 toward the arrangement axis D direction, a reflection direction of the circularly polarized light can be reversed.

That is, in FIGS. 2 and 3, the rotation direction of the optical axis 40A toward the arrangement axis D direction is clockwise, and one circularly polarized light is reflected in a state where it is tilted in the arrangement axis D direction. By setting the rotation direction of the optical axis 40A to be counterclockwise, circularly polarized light is reflected in a state where it is tilted in a direction opposite to the arrangement axis D direction.

Further, in the liquid crystal layer having the same liquid crystal alignment pattern, the reflection direction is reversed by adjusting the helical turning direction of the liquid crystal compound 40, that is, the turning direction of circularly polarized light to be reflected.

For example, in a case where the helical turning direction is right-twisted, the liquid crystal layer selectively reflects right circularly polarized light, and has the liquid crystal alignment pattern in which the optical axis 40A rotates clockwise in the arrangement axis D direction. As a result, the right circularly polarized light is reflected in a state where it is tilted in the arrangement axis D direction.

In addition, for example, in a case where the helical turning direction is left-twisted, the liquid crystal layer selectively reflects left circularly polarized light, and has the liquid crystal alignment pattern in which the optical axis 40A rotates clockwise in the arrangement axis D direction. As a result, the left circularly polarized light is reflected in a state where it is tilted in a direction opposite to the arrangement axis D direction.

As described above, in the cholesteric liquid crystal layer 34 (liquid crystal diffraction element), in the liquid crystal alignment pattern of the liquid crystal compound in the liquid crystal layer, the single period A as the length over which the optical axis of the liquid crystal compound rotates by 180° is the period (single period) of the diffraction structure. In addition, in the liquid crystal layer, the one in-plane direction (arrangement axis D direction) in which the optical axis of the liquid crystal compound changes while rotating is the periodic direction of the diffraction structure.

The length of the single period Λ of the cholesteric liquid crystal layer 34 is not particularly limited, and may be appropriately set depending on the incidence angle into the light guide unit 18, the size of diffraction of light for emitting the light from the light guide unit 18, and the like.

Here, in the cholesteric liquid crystal layer 34 having the liquid crystal alignment pattern, as the single period Λ decreases, the angle of reflected light with respect to the incidence light increases. That is, as the single period Λ decreases, reflected light can be reflected in a state where it is largely tilted with respect to specular reflection of incidence light.

For example, in a case where light is incident from the normal direction into the cholesteric liquid crystal layer 34, as the single period Λ decreases, the angle of reflected light with respect to the normal direction increases.

Accordingly, in the plane of the cholesteric liquid crystal layer 34 by adjusting the length of the single period Λ, the reflection angle of the incident infrared light in each of the in-plane regions can be adjusted such that the infrared light can be collimated.

As described above, the infrared light reflected from the eyeball E is diffused light. Accordingly, in the example shown in FIG. 1, in order to collimate the incident infrared light, the infrared light needs to be diffracted more largely toward the upper region in the drawing of the reflection element 20. That is, in the example shown in FIG. 1, for example, the single period of the cholesteric liquid crystal layer 34 gradually increases from the upper side toward the lower side in the drawing such that the incident infrared light can be collimated and reflected.

Likewise, by appropriately distributing the single period of the cholesteric liquid crystal layer 34 with respect to the direction perpendicular to the paper plane of FIG. 1, the infrared light can be collimated and reflected with higher parallelism.

In a case where an element other than the cholesteric liquid crystal layer 34 is used as the reflection element 20, the reflected infrared light may be collimated using a well-known method depending on the reflection element to be used.

In the cholesteric liquid crystal layer 34 shown in FIG. 2, on the X-Z plane, the liquid crystal compounds 40 (optical axes 40A) are aligned parallel to the main surface (X-Y plane).

However, the present invention is not limited to this configuration. That is, on the X-Z plane of the cholesteric liquid crystal layer 34, at least a part of the liquid crystal compounds 40 may be configured to be aligned (tilted) to be tilted with respect to the main surface (X-Y plane).

In this case, the tilt angles of the liquid crystal compounds 40 are not limited. In addition, the tilt angles of all of the liquid crystal compounds 40 may be uniform, or the liquid crystal compounds 40 having different tilt angles may be mixed.

In the eye image acquisition system according to the embodiment of the present invention, in a case where the cholesteric liquid crystal layer is used as the reflection element, the configuration of using the cholesteric liquid crystal layer that acts as the liquid crystal diffraction element having the liquid crystal alignment pattern is not limited.

That is, for example, by adjusting the disposition position and the angle of the cholesteric liquid crystal layer using a typical cholesteric liquid crystal layer that specularly reflects incidence light, the reflected infrared light may be incident into the light guide unit 18 at an angle where total reflection can occur. In this case, the infrared light may be collimated depending on the bending or the like of the reflection element 20 described below.

However, from the viewpoint that, for example, the reflected infrared light can be bent at a large angle with high efficiency to be incident into the light guide unit 18 by the small-sized element, it is preferable that the cholesteric liquid crystal layer that acts as the liquid crystal diffraction element having the liquid crystal alignment pattern is used as the reflection element.

In the eye image acquisition system according to the embodiment of the present invention, in a case where the reflection element 20 includes the cholesteric liquid crystal layer, as described above, the reflection element 20 may optionally include two cholesteric liquid crystal layers including a cholesteric liquid crystal layer that selectively reflects infrared light of right circularly polarized light and a cholesteric liquid crystal layer that selectively reflects infrared light of left circularly polarized light.

In addition, as the infrared source 16, a light source that emits circularly polarized light to be selectively reflected from the cholesteric liquid crystal layer may be used.

As described above, the infrared light guided by the light guide unit 18 is reflected from the emission element 24, is emitted from the light guide unit 18, and is incident into the imaging unit 26.

The emission element 24 reflects the incident infrared light at an angle different from specular reflection instead of being specularly reflected such that the infrared light is incident into the interface between the light guide unit 18 and air at an angle where total reflection does not occur, and is emitted from the light guide unit 18 to be incident into the imaging unit 26.

As the emission element 24, various examples described above as the reflection element 20 can be used. In particular, due to the same reason as that of the reflection element 20, the emission element 24 including the cholesteric liquid crystal layer is suitably used. Note that the emission element 24 does not need to collimate the reflected infrared light.

As shown in FIG. 1, in a case where the emission element 24 is positioned outside the virtual image generation optical system 14, the emission element 24 does not need to be transparent with respect to visible light.

The infrared light reflected from the emission element 24 and emitted from the light guide unit 18 is incident into the imaging unit 26. As a result, the infrared light reflected from the eyeball E of the user is imaged, that is, the image of the eyeball E of the user is acquired.

The imaging unit 26 is not limited, and various imaging elements (imaging apparatuses), such as a CCD sensor, a CMOS sensor, or a single photon avalanche diode (SPAD) sensor, that can image infrared light can be used.

As described above, the infrared light that is reflected from the eyeball E of the user is diffused light.

In a case where the diffused infrared light is incident into the light guide unit 18 as it is, the guided light is also diffused light. As a result, light components from various directions are mixed in the acquired image, and thus a plurality of images of the eyeball E may be seen to be separated instead of the single image of the eyeball E.

This inconvenience can be avoided by providing a collimating lens on an optical path of the infrared light reflected from the eyeball E. However, in this configuration, the image of visible light emitted from the image display apparatus 12 also transmits through the collimating lens to be bent such that the VR image observed by the user is also disordered.

On the other hand, in the present invention, the infrared light reflected from the eyeball E is collimated by the reflection element 20 introduced into the light guide unit 18. As a result, the disorder of the image of visible light does not occur, and the infrared light is collimated such that an appropriate image of the eyeball E can be acquired.

Here, in the example shown in FIG. 1, the reflection element 20 is planar and collimates the reflected infrared light, for example, by adjusting the single period A in the plane of the cholesteric liquid crystal layer 34.

However, the eye image acquisition system according to the embodiment of the present invention is not limited to this configuration, and the reflected infrared light may be collimated by adjusting the single period of the cholesteric liquid crystal layer 34 and further bending the reflection element 20 to be curved.

With this configuration, the infrared light can be more suitably collimated into parallel light by the reflection element 20.

In addition, in a case where the bent reflection element is used, it is preferable that a bent reflection element 20A is encompassed in the light guide unit 18 as conceptually shown in FIG. 6 instead of disposing the reflection element outside the light guide unit 18.

In FIG. 6, in order to clearly show the reflection element 20A and the light guide unit 18 encompassing the reflection element 20A, only the light guide unit 18, the reflection element 20A, the emission element 24, and the imaging unit 26 are shown.

In a case where the bent reflection element 20A is disposed outside the light guide unit 18, the image (light of the display image) of visible light emitted from the image display apparatus 12 transmits through the reflection element 20A. In this case, the image is incident into the bent surface of the reflection element 20A and emitted from the bent surface. Therefore, the image is curbed by bending such that the VR image observed by the user is disordered.

On the other hand, as shown in FIG. 6, by encompassing the bent reflection element 20A in the light guide unit 18, the image emitted from the image display apparatus 12 can transmit through the flat light guide unit 18. That is, the image is incident into the plane of the light guide unit 18 and emitted from the plane, and thus linearly transmits through the light guide unit 18. As a result, the disorder of the image can be prevented by the bent reflection element 20A.

A method of encompassing the bent reflection element 20A in the light guide unit 18 (light guide plate) is not particularly limited, and various well-known methods can be used.

For example, a method of embedding the surface of the reflection element 20A with a transparent resin or the like after forming the reflection element 20A that is bent on a surface of a transparent member forming a part of the light guide unit 18 can be used. In this case, the reflection element 20A may be formed on a surface of a curved transparent member, or the curved reflection element 20A may be formed on a planar transparent member to embed the surface of the reflection element 20A including a floating portion with a transparent resin or the like.

In addition, the light guide unit 18 encompassing the reflection element 20A can be formed by bonding and integrating a transparent member where the bent reflection element 20A is formed and a counterpart transparent member to each other.

As described above, the surface where the bent reflection element 20A is formed is not limited to a plane and may be a curved surface.

Examples of a method of forming the reflection element 20A on a plane or a curved surface include a method of applying a coating liquid for forming the reflection element to the surface of the transparent member using a well-known method such as a roll coating method, a gravure printing method, a spin coating method, a wire bar coating method, an extrusion coating method, a direct gravure coating method, a reverse gravure coating method, a die coating method, a spraying method, or an ink jet method and curing the applied coating film. In a case where the cholesteric liquid crystal layer 34 is used as the reflection element, the liquid crystal compound may be aligned in this case.

In addition, a method of forming the light guide unit 18 encompassing the bent reflection element 20A by preparing the reflection element in a film shape and subsequently bonding the film-shaped reflection element to the surface of the transparent member having a curved surface can also be used. Examples of a method of bonding the film and the transparent member include: insert molding as described in JP2004-322501A; and vacuum molding, injection molding, pressure forming, decompression coating molding, in-mold transfer, and mold pressing described in WO2010/1867A, JP2012-116094A, and the like.

A curvature of the bent surface of the bent reflection element 20A is not limited, and a curvature at which the reflected infrared light can be appropriately collimated into parallel light may be appropriately set depending on the diffused state or the like of the incident infrared light.

In a case where the reflection element 20A collimates the reflected light by adjusting the single period A using the cholesteric liquid crystal layer 34, the curvature at which the reflected infrared light can be appropriately collimated into parallel light may be set in consideration of the collimation by the diffraction of the reflected light.

In the eye image acquisition system according to the embodiment of the present invention, the collimation of the infrared light reflected by the reflection element 20 may be performed only by the bending of the reflection element. Alternatively, in the eye image acquisition system according to the embodiment of the present invention, the collimation of the infrared light reflected by the reflection element 20 may be performed only by adjusting the single period A of the cholesteric liquid crystal layer 34 as described above, that is, by adjusting the diffraction period of the diffraction element forming the reflection element.

However, in order to more suitably collimate the infrared light reflected from the eyeball E, as in the example shown in the drawing, it is preferable that the collimation by the bending of the reflection element 20 and the collimation by the adjustment of the single period A of the cholesteric liquid crystal layer 34 are combined to collimate the infrared light reflected from the reflection element 20.

In the virtual image display device 10 shown in FIG. 1, the eyeball E of the user is directly irradiated with the infrared light emitted from the infrared source 16. A method of emitting the infrared light from the infrared source 16 to the eyeball E is not limited to this configuration.

For example, as conceptually shown in FIG. 7, the infrared light emitted from the infrared source 16 may be emitted to the eyeball E through the light guide unit 18.

In the configuration shown in FIG. 7, the infrared light emitted from the infrared source 16 is incident into the eyeball E along with an optical path opposite to that of the light reflected from the eyeball E.

That is, the infrared light emitted from the infrared source 16 transmits through the light guide unit 18 to be incident into the emission element 24, is reflected from the emission element 24, and is incident into the light guide unit 18 at an angle where the light can be totally reflected and guided. The infrared light incident into the light guide unit 18 is guided in the light guide unit 18 while repeating total reflection, is incident into the reflection element 20, is emitted from the light guide unit 18, and is reflected in a direction toward the eyeball E to be incident into the eyeball E.

The infrared light incident into the eyeball E is reflected from the eyeball E, is reflected from the reflection element 20 to be incident into the light guide unit 18 as described above, is guided in the light guide unit 18, is reflected from the emission element 24, is emitted from the light guide unit 18, and is incident into the imaging unit 26 to be imaged.

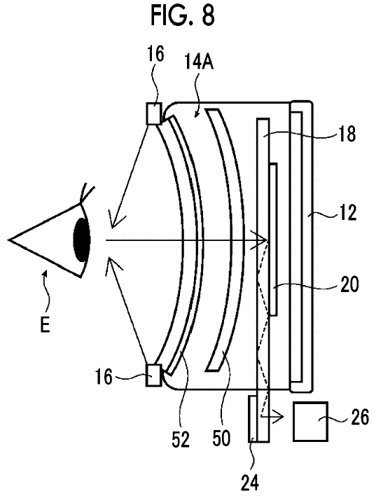

The virtual image display device according to the embodiment of the present invention may be used as a folded optical system including a half mirror 50 and a polarizing mirror 52 as shown in FIG. 8. That is, the virtual image display device according to the embodiment of the present invention may be used as a so-called pancake lens.

In the virtual image display device shown in FIG. 8, a part of the image (the light of the display image) emitted from the image display apparatus 12 transmits through the half mirror 50 to be incident into the polarizing mirror 52 in a virtual image generation optical system 14A.

The image is converted into, for example, right circularly polarized light by a circular polarizer (not shown) halfway an optical path to the polarizing mirror 52.

For example, the polarizing mirror 52 selectively reflects right circularly polarized light and allows transmission of left circularly polarized light. As described above, the image incident into the polarizing mirror 52 is converted into right circularly polarized light. Therefore, the image is reflected from the polarizing mirror 52.

The image reflected from the polarizing mirror 52 is incident into the half mirror 50 again, and a part thereof is reflected. During this reflection, the right circularly polarized light is converted into left circularly polarized light.

The image reflected from the half mirror 50 is incident into the polarizing mirror 52 again. Here, as described above, the polarizing mirror 52 reflects right circularly polarized light and allows transmission of left circularly polarized light. In addition, the image that is incident into the polarizing mirror 52 again is left circularly polarized light.

Accordingly, the image that is incident into the polarizing mirror 52 again transmits through the polarizing mirror 52, is incident into the eyeball E, and is observed by the user.

Even in the configurations shown in FIGS. 7 and 8, of course, the light guide unit 18 may be configured to encompass the bent reflection element 20A as shown in FIG. 6.

In addition, the virtual image display device according to the embodiment of the present invention is not limited to the VR system such as an HMD in the example shown in the drawing and can also be used for an AR system such as AR glasses.

Although the eye image acquisition system and the virtual image display device according to the embodiment of the present invention have been described above, the present invention is not limited to the above descriptions, and various improvements and changes may be made without departing from the gist of the present invention, of course.

The present invention can be suitably used, for example, for detecting the gaze direction and acquiring the expression of the user in a VR system, an AR system, and the like such as an HMD or AR glasses.

### EXPLANATION OF REFERENCES

10: virtual image display device
12: image display apparatus
14, 14A: virtual image generation optical system
16; infrared source
18: light guide unit
20, 20A: reflection element
24: emission element
26: imaging unit
30: support
32: alignment film
34: cholesteric liquid crystal layer
40: liquid crystal compound
40A: optical axis
42: bright portion
46: dark portion
50: half mirror
52: polarizing mirror
E: eyeball

What is claimed is:

1. An eye image acquisition system comprising:
an infrared source that emits infrared light to an eyeball of a user;
a light guide unit that guides the infrared light emitted from the infrared source and reflected from the eyeball of the user;
an emission element that emits the infrared light guided in the light guide unit from the light guide unit;
an imaging unit that images the infrared light emitted from the light guide unit by the emission element; and
a reflection element that reflects the infrared light emitted from the infrared source and reflected from the eyeball of the user and collimates the reflected light to guide the collimated infrared light in the light guide unit.

2. The eye image acquisition system according to claim 1,
wherein the reflection element is encompassed in the light guide unit and is bent.

3. The eye image acquisition system according to claim 2,
wherein the reflection element reflects infrared light using a cholesteric liquid crystal layer.

4. The eye image acquisition system according to claim 1,
wherein the reflection element reflects infrared light using a cholesteric liquid crystal layer,
the cholesteric liquid crystal layer has a liquid crystal alignment pattern in which an optical axis derived from a liquid crystal compound changes while continuously rotating in at least one in-plane direction, and
in a case where a length over which the optical axis rotates by 180° is set as a single period, the cholesteric liquid crystal layer has regions having different single periods in the plane.

5. The eye image acquisition system according to claim 1,
wherein the infrared light emitted from the infrared source is incident into and guided in the light guide unit, is emitted from the light guide unit by the reflection element, and is incident into the eyeball of the user.

6. A virtual image display device comprising:
the eye image acquisition system according to claim 1;
an image display apparatus; and
a virtual image generation optical system.

7. The virtual image display device according to claim 6,
wherein the virtual image generation optical system is a folded optical system.

8. The eye image acquisition system according to claim 2,
wherein the reflection element reflects infrared light using a cholesteric liquid crystal layer,
the cholesteric liquid crystal layer has a liquid crystal alignment pattern in which an optical axis derived from a liquid crystal compound changes while continuously rotating in at least one in-plane direction, and
in a case where a length over which the optical axis rotates by 180° is set as a single period, the cholesteric liquid crystal layer has regions having different single periods in the plane.

9. The eye image acquisition system according to claim 2,
wherein the infrared light emitted from the infrared source is incident into and guided in the light guide unit, is emitted from the light guide unit by the reflection element, and is incident into the eyeball of the user.

10. A virtual image display device comprising:
the eye image acquisition system according to claim 2;
an image display apparatus; and
a virtual image generation optical system.

11. The virtual image display device according to claim 10,
wherein the virtual image generation optical system is a folded optical system.

12. The eye image acquisition system according to claim 3,
wherein the reflection element reflects infrared light using a cholesteric liquid crystal layer,
the cholesteric liquid crystal layer has a liquid crystal alignment pattern in which an optical axis derived from a liquid crystal compound changes while continuously rotating in at least one in-plane direction, and
in a case where a length over which the optical axis rotates by 180° is set as a single period, the cholesteric liquid crystal layer has regions having different single periods in the plane.

13. The eye image acquisition system according to claim 3,
wherein the infrared light emitted from the infrared source is incident into and guided in the light guide unit, is emitted from the light guide unit by the reflection element, and is incident into the eyeball of the user.

14. A virtual image display device comprising:
the eye image acquisition system according to claim 3;
an image display apparatus; and
a virtual image generation optical system.

15. The virtual image display device according to claim 14,
wherein the virtual image generation optical system is a folded optical system.

16. The eye image acquisition system according to claim 4,
wherein the infrared light emitted from the infrared source is incident into and guided in the light guide unit, is emitted from the light guide unit by the reflection element, and is incident into the eyeball of the user.

17. A virtual image display device comprising:
the eye image acquisition system according to claim 4;
an image display apparatus; and
a virtual image generation optical system.

18. The virtual image display device according to claim 17,
wherein the virtual image generation optical system is a folded optical system.

19. A virtual image display device comprising:
the eye image acquisition system according to claim 5;
an image display apparatus; and
a virtual image generation optical system.

20. The virtual image display device according to claim 19,
wherein the virtual image generation optical system is a folded optical system.
